(19) United States
(12) Patent Application Publication
(10) Pub. No.: US 2026/0131782 A1
(43) Pub. Date: May 14, 2026

(54) SYSTEM AND METHOD FOR TRAILER DIMENSION ESTIMATION

(71) Applicant: Torc Robotics, Inc., Blacksburg, VA (US)

(72) Inventors: Carlo Elwinger, Maulbronn (DE); Janine Guenther, Leinfelden (DE); Simon Schaefer, Stuttgart (DE)

(21) Appl. No.: 18/948,013

(22) Filed: Nov. 14, 2024

(51) Int. Cl. B60W 30/09; B60W 40/12; G06T 7/13; G06T 7/60

(52) U.S. Cl. CPC B60W 30/09; B60W 40/12; G06T 7/13; G06T 7/60; B60W 2300/14; B60W 2420/403; B60W 2420/408; B60W 2530/201; G06T 2207/10028; G06T 2207/30252

(57) ABSTRACT

A system for trailer dimension estimation is provided. The system includes one or more sensors associated with a vehicle, the one or more sensors each having a field-of-view. The vehicle configured to couple with a trailer. The system includes a processing device configured to execute instructions stored in a memory to perform operations including, when the trailer is coupled with the vehicle, determining if a first edge or a first point of the trailer is detected within the field-of-view of the one or more sensors. If the first edge or the first point of the trailer is detected within the field-of-view of the one or more sensors, the operations include estimating a dimension of the trailer based on a signal from the one or more sensors.

### TECHNICAL FIELD

The field of the disclosure relates to trailer dimension estimation and, in particular, to a system capable of estimating the dimensions of a trailer coupled to a vehicle such that the estimated dimensions are usable for route planning and vehicle operation to ensure regulatory compliance and infrastructure compatibility.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

One aspect of behavior and planning technologies is determining which routes the vehicle is permitted to traverse based on the trailer coupled to the vehicle. In particular, the dimensions and type of the trailer can vary significantly based on the cargo being transported. For example, the vehicle can haul a flatbed trailer or a step-deck trailer. Such changes in trailer characteristics, as well as the size of the cargo, can affect the route along which the vehicle is permitted to travel, as well as certain behaviors of the autonomous vehicle to ensure safe travel along the route. The trailer and cargo characteristics can have an effect on, e.g., the stability and control of the vehicle, the turning radius of the vehicle, lane-keeping and collision avoidance, infrastructure compatibility, regulatory compliance, sensor and perception considerations, combinations thereof, or the like.

Accordingly, there exists a need for a system and a method of trailer dimension estimation for an autonomous vehicle that is usable to assist with route and behavior planning. These and other needs are met by the exemplary system for trailer dimension estimation discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for trailer dimension estimation is provided. The system includes one or more sensors associated with a vehicle. The one or more sensors each have a field-of-view. The vehicle is configured to couple (e.g., releasably or fixed) with a trailer. The trailer includes a front section configured to be disposed proximal to the vehicle and a rear section with a rear edge or a rear point disposed distal to the vehicle. The system includes a processing device in communication with the one or more sensors. The processing device is configured to execute instructions stored in a memory to perform operations that includes, when the trailer is coupled with the vehicle, determining if a first edge (e.g., the rear edge) or a first point (e.g., the rear point) of the trailer is detected within the field-of-view of the one or more sensors. If the first edge or the first point of the trailer is detected within the field-of-view of the one or more sensors, the operations include estimating a dimension of the trailer based on a signal from the one or more sensors.

In some embodiments, the one or more sensors can include, e.g., LiDAR, radar, a camera, combinations thereof, or the like. In some embodiments, the vehicle can be an autonomous or semi-autonomous vehicle. The dimension of the trailer includes at least one of a trailer length or a trailer width. The one or more sensors can include a first sensor disposed on a first side of the vehicle and a second sensor disposed on a second side of the vehicle. In some embodiments, estimating the dimension of the trailer can include detecting a first section of the rear edge or the rear point with the first sensor and detecting a second section of the rear edge or the rear point with the second sensor. In some embodiments, estimating the dimension of the trailer can include estimating the trailer width based on the first section and the second section of the rear edge or the rear point of the trailer.

If the rear edge or the rear point of the trailer is not detected within the field-of-view of the one or more sensors, the operations can include initiating a turn motion of the vehicle (rearward or frontward). The operations can include continuing the turn motion of the vehicle until the rear edge or the rear point of the trailer is detected within the field-of-view of the one or more sensors. The operations can include generating a trailer model representative of the estimated dimension of the trailer. The system can include a database configured to electronically store the trailer model and the dimension of the trailer.

In some embodiments, the operations can include transmitting the trailer model to a mission control. The mission control can include a route generation unit configured to generate a mission route for the vehicle based on the trailer model. The mission route generated by the route generation unit ensures regulatory compliance along the mission route for the vehicle and the trailer. The mission control can include a vehicle control unit configured to generate a limited behavior for the vehicle based on the trailer model. The limited behavior for the vehicle ensures prevention of collisions of the trailer during turning of the vehicle.

In another aspect, an exemplary computer-implemented method for trailer dimension estimation is provided. The method includes coupling a trailer with a vehicle. The vehicle includes one or more sensors associated with the vehicle. The one or more sensors each have a field-of-view. The trailer includes a front section disposed proximal to the vehicle and a rear section with a rear edge or a rear point disposed distal to the vehicle. The method includes executing instructions stored in a memory with a processing device in communication with the one or more sensors to perform operations that include determining if a first edge (e.g., the rear edge) or a first point (e.g., the rear point) of the trailer is detected within the field-of-view of the one or more sensors. If the first edge or the first point of the trailer is detected within the field-of-view of the one or more sensors, the operations include estimating a dimension of the trailer based on a signal from the one or more sensors.

In some embodiments, the one or more sensors can include a first sensor disposed on a first side of the vehicle and a second sensor disposed on a second side of the vehicle. In some embodiments, estimating the dimension of the trailer can include detecting a first section of the rear edge or the rear point with the first sensor and detecting a second section of the rear edge or the rear point with the second sensor. The operations can include estimating the trailer width based on the first section and the second section of the rear edge or the rear point of the trailer. If the rear edge or the rear point of the trailer is not detected within the field-of-view of the one or more sensors, the operations can include initiating a turn motion of the vehicle and continuing the turn motion of the vehicle until the rear edge or the rear point of the trailer is detected within the field-of-view of the one or more sensors.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for trailer dimension estimation.

FIG. 7 is a flowchart of a method for trailer dimension estimation.

FIG. 8 is a diagrammatic side view of a vehicle and trailer, including a sensor mounted to the vehicle.

FIG. 9 is a diagrammatic top view of a vehicle and trailer, and field-of-views of sensors mounted to the vehicle.

FIG. 10 is a diagrammatic top view of a vehicle and trailer, and a blocked field-of-view of a sensor mounted to the vehicle.

FIG. 11 is a diagrammatic top view of a vehicle and trailer, and a turning action initiated by the vehicle to accurately detect and estimate a cargo dimension on the trailer.

FIG. 12 is a block diagram and flow chart of an exemplary method for trailer dimension estimation, including vehicle behavior modification based on the estimated trailer dimensions.

FIG. 13 is a block diagram and flow chart of an exemplary method for trailer dimension estimation, including vehicle behavior planning and departure check based on the estimated trailer dimensions.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for trailer dimension estimation provides an automatic determination of the trailer size (and, in some embodiments, the cargo size), and generates a mission route and vehicle behavior control based on the trailer (and cargo) dimensions. The exemplary system ensures that several factors, e.g., stability and control, turning radius, lane-keep, collision avoidance, infrastructure compatibility, regulatory compliance, sensor and perception considerations, combinations thereof, or the like, are each adjusted and considered based on the trailer and cargo estimations, ensuring successful mission completion of the autonomous vehicle.

Despite different trailers being used with the vehicle, the system can be used to automatically determine the size of the trailer to adjust the vehicle operation parameters, as well as determining a mission route that accommodates the trailer size. Trailers having different dimensions, e.g., length, width, or both, can therefore be interchanged based on transportation requirements and the system can updated in real-time to ensure the appropriate route and vehicle behavior is selected. The swept path width and regulatory compliance (e.g., for oversize loads) is therefore met based on updates to the mission route and vehicle behavior. Similar changes in cargo along a route (or at starting points of a route) can be used to update the trailer and cargo model, for corresponding generation of a mission route that can accommodate the specific cargo being transported. For example, for oversize loads, the system can generate a route with infrastructure sufficient to accommodate passage of the vehicle and trailer.

The exemplary system can be used to generate an internal trailer model that is used by the processing device of the vehicle to regulate behavior of the vehicle along the route in order to avoid collisions with surrounding vehicles and/or objects, e.g., during turns, lane changes, parking, or the like. The system therefore provides the ability to automatically adapt the behavior of the vehicle based on the trailer dimension estimation to optimize route selection and vehicle performance, improving the overall departure check and planning for the mission. In particular, the system can determine the dimensions of the trailer (and cargo) with one or more sensors associated with the vehicle, and updates a trailer model used internally for departure check and planning by adapting the behavior of the vehicle during a planned mission.

In operation, one or more sensors of the vehicle can be used to detect rear points and/or the rear edge of the trailer. Based on such detection from the sensors, the system can extract the estimated trailer dimensions. The sensors can similarly be used to detect edges of the cargo on the trailer to estimate the width, height and/or depth of the cargo. This information is used to update an internal trailer model, which is used to update the behavior of the vehicle along a selected route. For example, based on the trailer and/or cargo dimensions, the system can, e.g., restrict the minimum turning radius for the vehicle, adapt lane centering offset based on the trailer width, restrict the operational design domain (ODD) for infrastructure compatibility, check regulatory compliance, combinations thereof, or the like. As used herein, ODD refers to the specific conditions under which an autonomous vehicle (AV) is designed to operate.

In situations where the trailer is wider than the vehicle, e.g., cab, tractor, or the like, near the front and even wider than this near the rear of the trailer, the system can underestimate the width due to the wide part at the front blocking the rear trailer edge view in the field-of-view of the sensors. To mitigate the risk, the vehicle can be actuated to drive in a curved or turning operation to increase the amount of the trailer visible in the field-of-view of the sensor(s). Until the curving or turning operation is initiated, the worst-case estimation can be assumed by the system to avoid collisions with other vehicles and/or objects. In some embodiments, the worst-case estimation can be based on input or predefined maximum cargo and/or trailer dimensions, which can be based on the maximum cargo/trailer capable of being used with the vehicle. The worst-case estimation can therefore be used when part or all of the cargo and/or trailer is occluded, until the curving or turning operation is used and the edges of the cargo and/or trailer are visible in the field-of-view of the sensor(s).

After the trailer and/or cargo dimensions are estimated, the system can enter the planning stage. At the planning stage, departure check is performed which includes checking of the cargo size to determine if it is compliant with regulations, e.g., in case of a flatbed trailer and other trailer types where oversized cargo can be transported by the vehicle. The system plans a trajectory to adapt behavior changes of the vehicle, and actuates motion controls to move the vehicle and trailer along the mission route.

For stability and control, the system can incorporate the trailer dimension into the vehicle model to enhance the stability and control algorithms. The autonomous system can better predict and compensate for changes in dynamics that results from variations in trailer dimensions. Similar stability and control can be performed based on the estimated cargo dimensions to ensure safe dynamics are used for the vehicle operations.

Accurate modeling of the trailer dimension (and cargo dimension) allows for more precise calculations and control of the turning radius for the vehicle. This enables the autonomous vehicle to plan and execute turns more effectively, considering the specific length of the trailer (and size of the cargo) and avoid situations where the turning radius may be compromised. Depending on the trailer dimensions (and cargo size), the autonomous vehicle can adapt its turning radius to avoid or minimize the need to compromise the turning radius such as cutting curves where the autonomous vehicle would move to the adjacent lane.

The autonomous vehicle can adjust lane keeping to stay within its lane for different trailer dimensions (and cargo dimensions). By incorporating the trailer (and cargo) dimensions into the model, the autonomous system ensures compliance with infrastructure specifications and regulatory standards related to vehicle dimensions. This allows for seamless integration with existing road networks and transportation systems.

In terms of regulatory compliance, during departure check, the system checks the cargo size to determine if it is compliant with regulations, e.g., in case of a flatbed trailer and other trailer types where oversized cargo can be transported. Incorporating trailer dimensions into the model ensures that the autonomous vehicle adheres to regulatory standards governing vehicle size. This compliance is crucial for legal operation and avoids potential issues related to traffic violations and/or safety concerns associated with non-compliance.

The system further assists with sensor and perception considerations. In particular, developing a model that accounts for trailer dimensions allows for better planning of sensor placement and coverage. The autonomous system can mitigate blind spots created by the trailer, optimizing the arrangement of cameras, LiDAR, and radar (for example) for improved perception and situational awareness.

The exemplary system offers several advantages, e.g., increased safety through conservative driving behavior, ensuring smoother and safer vehicle operation, compliance with regulations, and restricted behavior based on minimum turning radius for changing routes, if required. In situations where the planned route faces challenges, the system can use this information to intelligently choose alternative routes that are feasible and comply with the vehicle's turning capabilities.

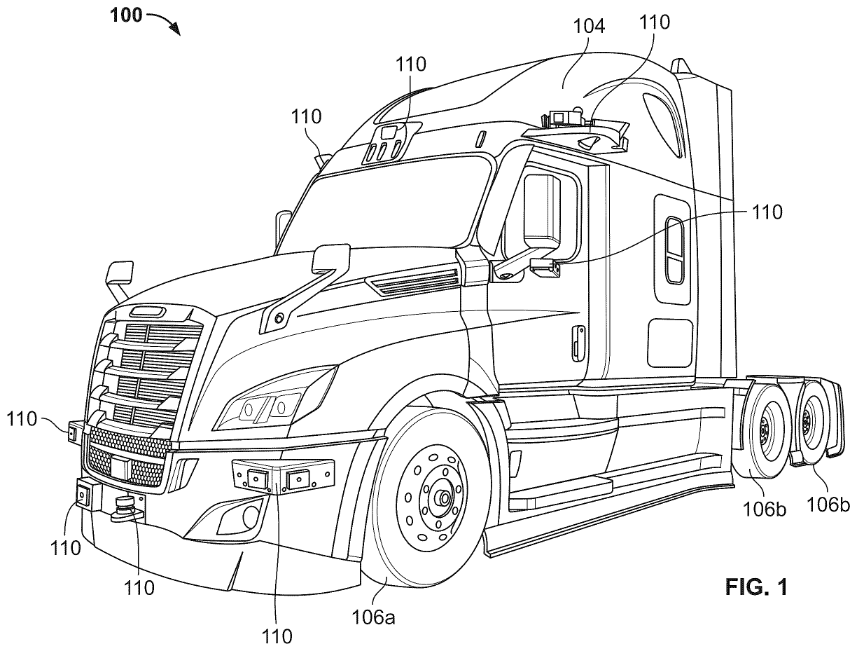

Various embodiments in the present disclosure are described with reference to FIGS. 1-12 below.

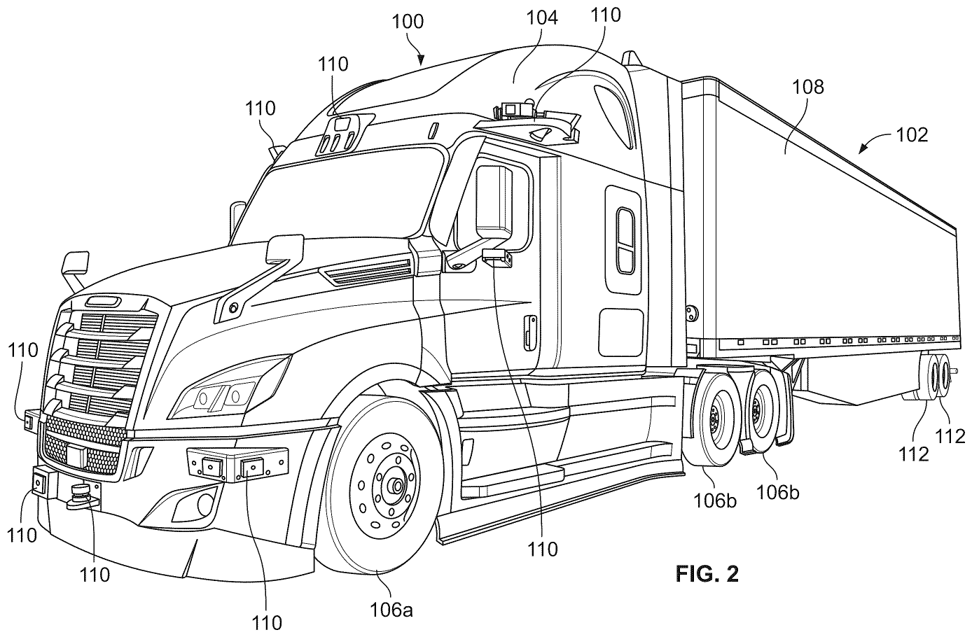

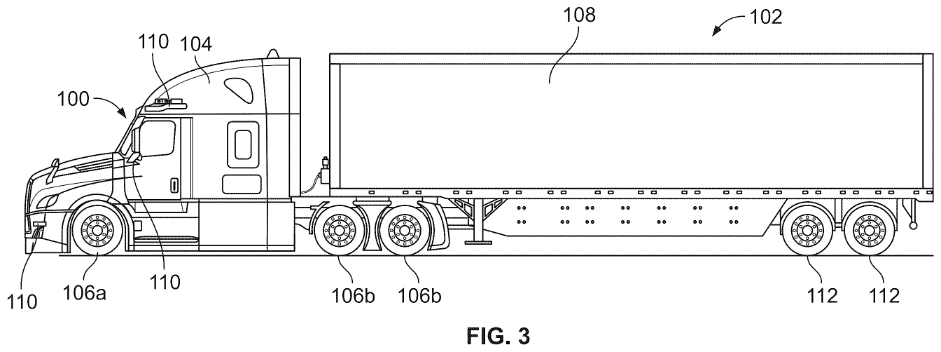

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releaseably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

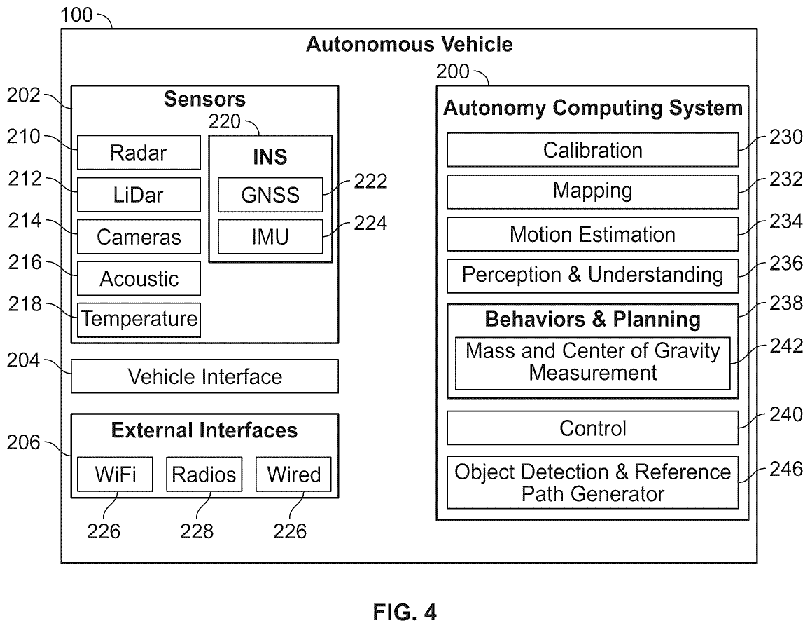

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4autonomy (e.g., high driving automation), or Level 3 autonomy (e.g., conditional driving automation). As used herein the term “autonomous” includes both fully autonomous and semi-autonomous.

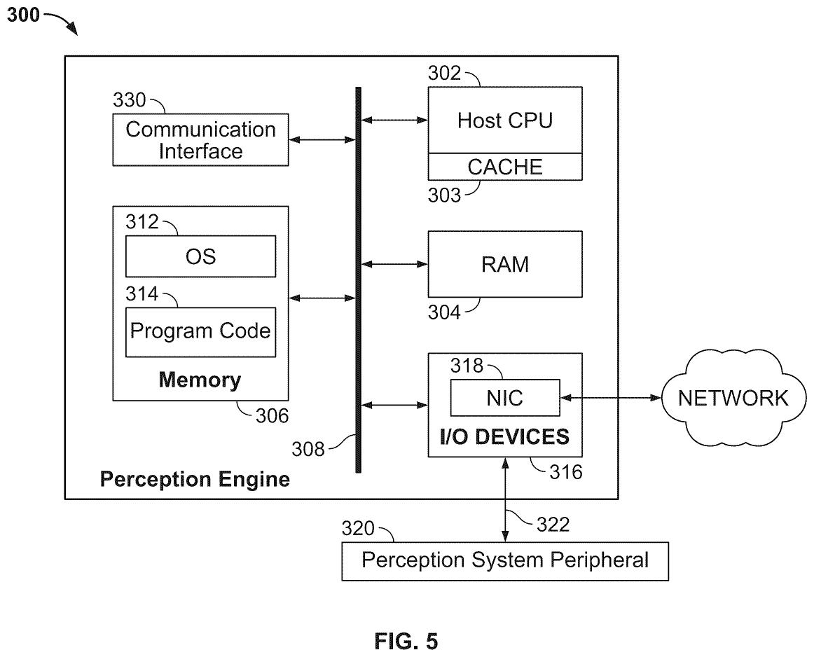

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

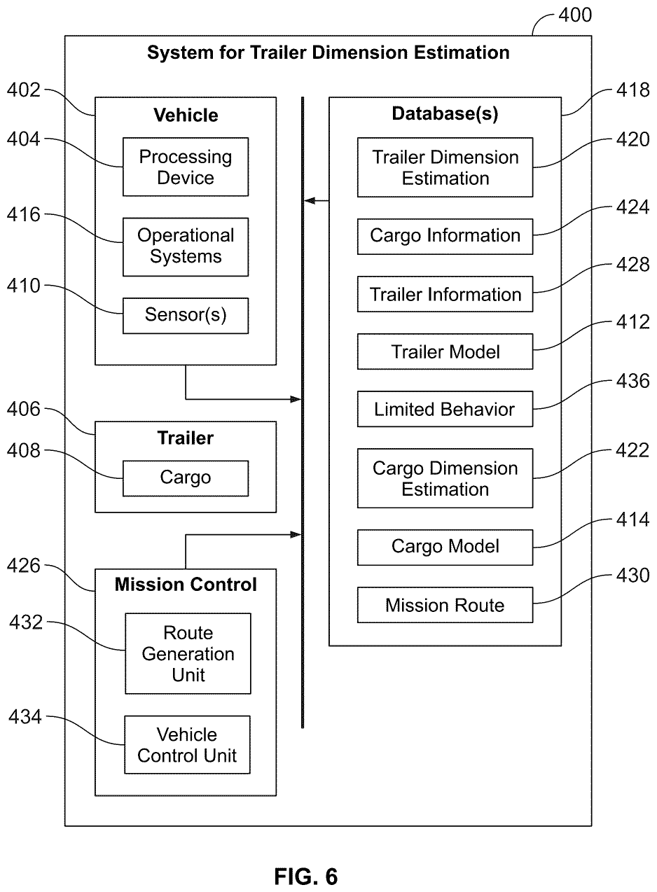

FIG. 6 is a block diagram of an exemplary system 400 for trailer dimension estimation. The system 400 generally includes one or more vehicles 402 (e.g., autonomous vehicle 100). Each vehicle 402 includes a processing device 404 (e.g., computing system 200, computing system 300, or the like) configured to receive and process data for estimating the dimensions of a trailer 406 coupled to the vehicle 402 (and optionally the dimensions of cargo 408 on the trailer 406). At least some of the data received by the processing device 404 can be data from one or more sensors 410 (e.g., sensors 202). For example, the sensors 410 can detect one or more points or edges of the trailer 406 (and cargo 408), and the processing device 404 can generate a trailer model 412 representative of the trailer 406 dimensions. The processing device 404 can similarly generate a cargo model 414 representative of the cargo 408 dimensions based on detection of points or edges of the cargo 408. These models 412, 414 can be used to regulate one or more of the operational systems 416 (e.g., autonomy computing system 200) for regulating the behavior of operation of the vehicle 402.

The vehicle 402 can include one or more databases 418 (e.g., memory 306) configured to receive and electronically store data. In some embodiments, the database 418 can be stored externally from the vehicle 402 and the vehicle 402 can be in communication with the external database 418 for receiving and/or transmitting data associated with the system 400. In some embodiments, the vehicle 402 can include at least one sensor 410 on one side of the vehicle 402 (e.g., the left side) and another sensor 410 on the opposing side of the vehicle 402 (e.g., the right side). Each of the sensors 410 includes a field-of-view in which the sensors 410 can be used to detect objects and estimate their distance and/or dimensions. With respect to the trailer 406, the sensors 410 can be used to detect the rearmost point and/or edge of the trailer 406. If this rearmost point and/or edge of the trailer 406 is detected, the system 400 estimates the length of the trailer 406. If two opposing rearmost points of the trailer 406 are detected, the points can be used to estimate the width of the trailer 406. These dimensions can be saved as trailer dimension estimation 420 in the database 418.

If the cargo 408 on the trailer 406 obstructs the field-of-view of the sensors 410, the system 400 can actuate the operational systems 416 to initiate a turning operation of the vehicle 402, thereby repositioning the vehicle 402 relative to the trailer 406 to a point where the rearmost point(s) and/or edge is within the field-of-view of the sensors 410. In some embodiments, such turning operation can be conducted to the left and subsequently the right to ensure the sensors 410 on either side of the vehicle 402 are capable of detecting the rearmost point and/or edge of the trailer 406 within their field-of-view. The angular motion of the vehicle 402 thereby adjusts the angle of the field-of-view to allow the sensors 410 to reposition the trailer 406 such that endpoints and/or edges can be detected for accurate trailer dimension estimation 420 (and subsequent trailer model 412 generation). In some embodiments, trailer information 428 can be input into the system 400 via, e.g., a user interface at a remote mission control 426, to assist with estimating the trailer 406 dimensions. If the angular motion of the vehicle 402 fails to adjust the angle of the field-of-view sufficiently and the sensors 410 still fail to detect the endpoints and/or edges of the trailer 406, the system 400 can transmit a signal to mission control that a failed departure check has occurred and the vehicle 402 cannot depart until the trailer 406 dimensions have been manually confirmed and input into the system 400.

A similar operation can be performed by the system 400 for estimating the dimensions of the cargo 408 on the trailer 406. In particular, the field-of-view of the sensors 410 can be used to detect the side edges, rear edges, top edges and/or bottom edges of the cargo 408, and this information can be used by the processing device 404 to estimate the size of the cargo 408 to generate the cargo dimension estimation 422. If the cargo 408 is obstructed within the field-of-view of the sensors 410, the vehicle 402 can be actuated to perform the turning operation in one or both directions until the respective edges of the cargo 408 are visible in the field-of-view of the sensors 410. If the turning operation is performed and the edges of the cargo 408 are still not visible, the system 400 can transmit a signal to mission control that a failed departure check has occurred and the vehicle 402 cannot depart until the cargo 408 dimensions have been manually confirmed and input into the system 400.

In some embodiments, the vehicle 402 can be actuated to perform the turning operation in one or both directions to determine if a proximal cargo 408 is obstructing a distal cargo 408 positioned on the same trailer 406, thereby adjusting the cargo dimension estimation 422 (and the associated model 414) to account for all or most of the cargo 408 on the trailer 406. In some embodiments, cargo information 424 can be input into the system 400 via, e.g., a user interface at the remote mission control 426, to assist with estimating the cargo 408 dimensions.

The trailer model 412 (and optionally the cargo model 414) can be input to mission control 426 to generate a mission route 430 for the vehicle 402. Mission control 426 can include additional details regarding the starting, ending and any intermediate points for the vehicle 402 to take along the route 430. A route generation unit 432 of mission control 426 receives the input information and determines which mission route 430 (or routes) comply with safety, infrastructure, and regulatory limitations. If multiple routes 430 are capable of accommodating the vehicle 402 with the trailer 406 and cargo 408, the system 400 can output this information via a user interface at mission control 426 for user selection of the route. In some embodiments, the most time-efficient route can be automatically selected by the system 400.

Similarly, the input information can be processed by a vehicle control unit 434 of mission control 426. The vehicle control unit 434 generates limited behavior 436 for the vehicle 402, such as controlling the speed at which the vehicle 402 can travel and minimum turning radii for the vehicle 402, to ensure the vehicle 402 (with the trailer 406 and cargo 408) can safely travel along the mission route 430. The limited behavior 436 can be correlated with the operational systems 416 to ensure the vehicle 402 is appropriate controlled. The system 400 can therefore be used to automatically generate a route 430 and vehicle behavior 436 that allows the vehicle 402 to transport the cargo 408 in a safe and compliant manner.

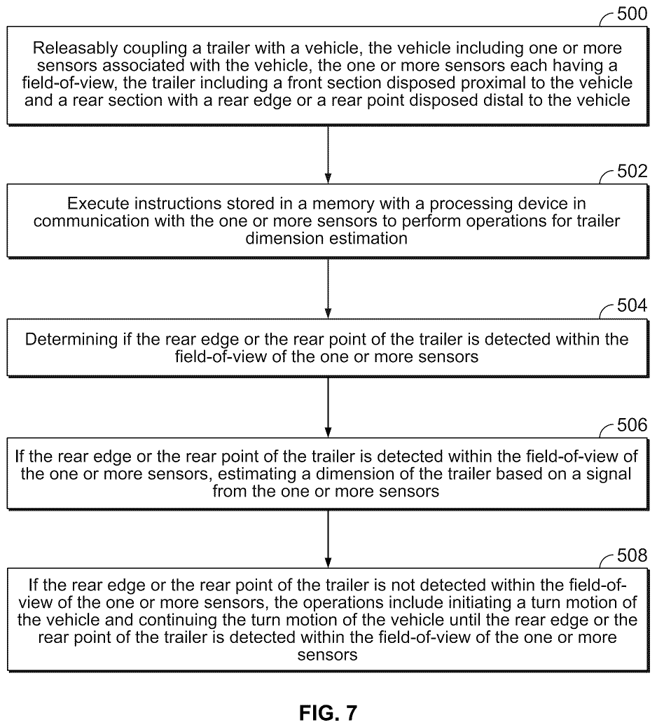

FIG. 7 is a flowchart of a method of trailer dimension estimation by the exemplary system 400 discussed herein. At 500, a trailer is releasably coupled with a vehicle. The vehicle includes one or more sensors associated with the vehicle. The sensors each have a field-of-view. The trailer includes a front section disposed proximal to the vehicle and a rear section with a rear edge or a rear point disposed distal to the vehicle. At 502, instructions stored in a memory are executed with a processing device in communication with the sensors to perform operations for trailer dimension estimation.

At 504, the operations include determining if the rear edge or the rear point of the trailer is detected within the field-of-view of the one or more sensors. At 506, if the rear edge or the rear point of the trailer is detected within the field-of-view of the one or more sensors, the operations include estimating a dimension of the trailer based on a signal from the one or more sensors. At 508, if the rear edge or the rear point of the trailer is not detected within the field-of-view of the one or more sensors, the operations include initiating a turn motion of the vehicle and continuing the turn motion of the vehicle until the rear edge or the rear point of the trailer is detected within the field-of-view of the one or more sensors.

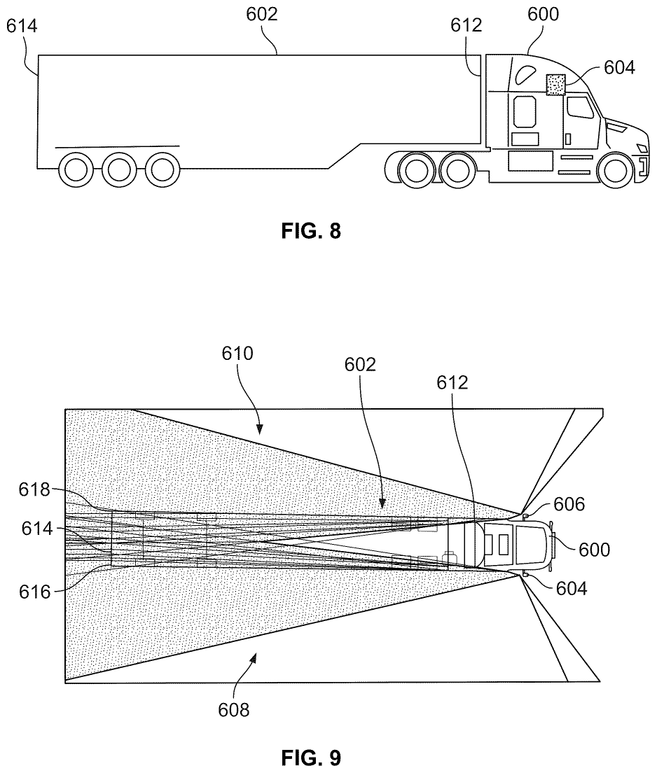

FIG. 8 is a diagrammatic side view of a vehicle 600 (e.g., a cab, a truck, or the like) and a trailer 602 coupled to the vehicle 600, and FIG. 9 is a diagrammatic top view of the vehicle 600 and trailer 602. The vehicle 600 includes at least one sensor 604 on the right side and at least one sensor 606 on the opposing left side. Each sensor 604, 606 includes a respective field-of-view 608, 610 through which detection of points/edges of the trailer 602 and/or cargo can be made.

As an example, the trailer 602 in FIGS. 8 and 9 includes a front edge or portion 612 disposed proximal to the vehicle 600, and a rear edge or portion 614 disposed distal to the vehicle 600. The rear portion 614 of the trailer 602 includes opposing rear points 616, 618 that define the widest areas of the trailer 602. The vehicle 600 can be regulated such that the rear portion 614 and/or the rear points 616, 618 are detected within the respective field-of-views 608, 610 of the sensors 604, 606, with the respective detected points 616, 618 usable to estimate the width of the trailer 602 and the overall length of the trailer 602. This information is used by the system to generate a mission route along which the vehicle 600 can travel with the trailer 602 without violating safety or regulatory laws, and further generates behavior limitations for the vehicle 600 to ensure safe passage of the vehicle 600 and trailer 602 along the mission route.

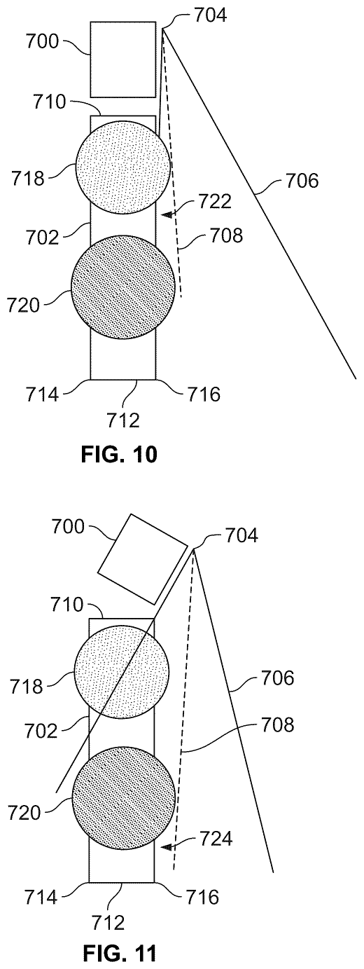

FIGS. 10 and 11 illustrate a vehicle 700 and trailer 702 operated in a turning action to allow a sensor 704 to detect desired portions of the trailer 702 within its field-of-view 706. In particular, the solid lines represent the field-of-view 706 of the sensor 704, while the dashed line represents the line-of-sight 708 of the sensor 704. The trailer 702 includes a frontmost section 710 and an opposing rearmost section 712 (e.g., rearmost edge) with opposing rear points 714, 716.

The trailer 702 accommodates a first or proximal cargo 718 and a second or distal cargo 720 (relative to the vehicle 700). Due to the positioning of the cargo 718, as shown in FIG. 10, a portion 722 of the field-of-view 706 is obstructed by edges of the cargo 718. This results in the sensor 704 being incapable of detected edges of the cargo 720. To ensure the cargo 720 size is accurately estimated, as shown in FIG. 11, the vehicle 700 is actuated to perform a turning action or operation until the edge of the cargo 720 is within the line-of-sight 708 of the sensor 704 (despite a portion 724 of the field-of-view 706 remaining obstructed). The turning action can be continued until the rearmost section 712 and/or rear points 714, 716 are within the line-of-sight 708 of the sensor 704 to estimate the dimensions of the trailer 702.

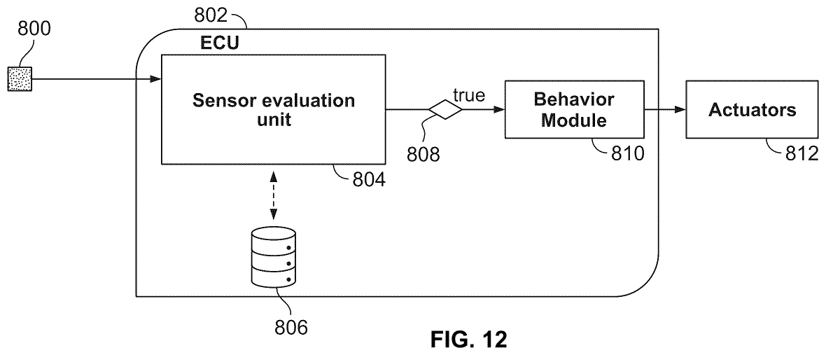

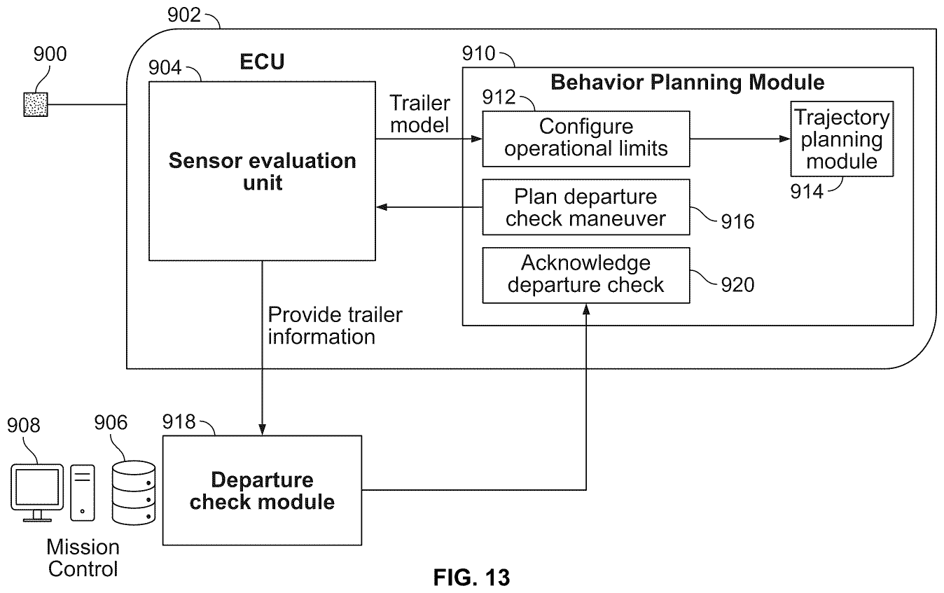

FIG. 12 is a block diagram and flow chart of an exemplary method for trailer dimension estimation (and subsequent vehicle control). At 800, the sensor(s) perceive the trailer dimension(s) and orientation (and cargo dimensions). This information is input to the electronic control unit (ECU) 802 for processing. The ECU 802 includes a sensor evaluation unit 804 which updates the internal trailer model stored in a database 806. Based on the updated trailer model, at 808, the system determines if a behavior change is required for operation of the vehicle. For example, if the trailer and/or cargo has been changed and modification of the vehicle operation is needed, the system makes a determination at 808 for this change. At 810, a behavior module of the system is used to adapt/restrict the driving or operating behavior of the vehicle based on the updated trailer module. At 812, actuators of the vehicle are controlled to operate based on the restrictions generated by the system. This allows the vehicle to operate safely along the mission route, and adjusts the vehicle operation in real-time based on changes the trailer and/or cargo.

FIG. 13 is a block diagram and flow chart of an exemplary method for trailer dimension estimation (and subsequent vehicle control, including a departure check). At 800, the sensor(s) perceive the trailer dimension(s) and orientation (and cargo dimensions). The sensors can include, e.g., LIDAR for rear left/right edge detection, camera(s) for rear left/right edge detection, radar, combinations thereof, or the like. This information is input to the electronic control unit (ECU) 902 for processing. The ECU 902 includes a sensor evaluation unit 904 which, e.g., perceives the trailer dimension, perceives the trailer model, updates the trailer model, or the like. This information can be stored in a database 906 which is in communication with mission control 908.

The updated trailer model is transmitted to a behavior planning module 910, which determines if a behavior change is required for operation of the vehicle. The module 910 can include configurable operational limits 912 for the vehicle, such as the minimum turning radius for the vehicle based on the updated trailer model, speed regulations, height limits along the mission route, or the like. Based on the configurable operational limits 912, the system generates a mission route and regulates operation of the vehicle along the mission route with a trajectory planning module 914.

The module 910 can generate a plan departure check maneuver 916, which is transmitted to the unit 904. The plan departure check maneuver 916 includes steps 500-508 discussed with respect to FIG. 7. The unit 904 can transmit the trailer model information to a departure check module 918, which can check the regulatory compliance of the vehicle, trailer, cargo and/or route generation, and checks the route infrastructure compliance to ensure the vehicle can travel along the planned route with the trailer and/or cargo dimensions. If the departure check module 918 determines that the regulator and route infrastructure compliance has been met, an acknowledgement 920 of the departure check can be transmitted to the module 910, thereby permitting the vehicle to depart the facility. If the compliance has not been met, e.g., if the trailer and/or cargo estimation is not sufficiently accurate because edges of the trailer and/or cargo have not been detected by the sensors, the module 918 can transmit this information to the module 910 and/or mission control 908, requiring manual confirmation and input of the trailer and/or cargo dimensions before the vehicle is permitted to depart the facility.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for trailer dimension estimation, comprising:
one or more sensors associated with a vehicle, the one or more sensors each having a field-of-view, and the vehicle configured to couple with a trailer, wherein the trailer includes a front section configured to be disposed proximal to the vehicle and a rear section with a rear edge or a rear point disposed distal to the vehicle; and
a processing device in communication with the one or more sensors, wherein the processing device is configured to execute instructions stored in a memory to perform operations comprising:
when the trailer is coupled with the vehicle, determining if a first edge or a first point of the trailer is detected within the field-of-view of the one or more sensors; and
if the first edge or the first point of the trailer is detected within the field-of-view of the one or more sensors, estimating a dimension of the trailer based on a signal from the one or more sensors.

2. The system of claim 1, wherein the one or more sensors include at least one of LiDAR, radar, or a camera.

3. The system of claim 1, wherein the vehicle is an autonomous vehicle.

4. The system of claim 1, wherein the dimension of the trailer includes at least one of a trailer length or a trailer width.

5. The system of claim 4, wherein the one or more sensors include a first sensor disposed on a first side of the vehicle and a second sensor disposed on a second side of the vehicle.

6. The system of claim 5, wherein the first edge is the rear edge and the first point is the rear point, and wherein estimating the dimension of the trailer includes detecting a first section of the rear edge or the rear point with the first sensor and detecting a second section of the rear edge or the rear point with the second sensor.

7. The system of claim 6, wherein estimating the dimension of the trailer includes estimating the trailer width based on the first section and the second section of the rear edge or the rear point of the trailer.

8. The system of claim 1, wherein the first edge is the rear edge and the first point is the rear point, and wherein if the rear edge or the rear point of the trailer is not detected within the field-of-view of the one or more sensors, the operations comprise initiating a turn motion of the vehicle.

9. The system of claim 8, wherein the operations comprise continuing the turn motion of the vehicle until the rear edge or the rear point of the trailer is detected within the field-of-view of the one or more sensors.

10. The system of claim 1, wherein the operations comprise generating a trailer model representative of the estimated dimension of the trailer.

11. The system of claim 10, comprising a database configured to electronically store the trailer model and the dimension of the trailer.

12. The system of claim 10, wherein the operations comprise transmitting the trailer model to a mission control.

13. The system of claim 12, wherein the mission control includes a route generation unit configured to generate a mission route for the vehicle based on the trailer model.

14. The system of claim 13, wherein the mission route generated by the route generation unit ensures regulatory compliance along the mission route for the vehicle and the trailer.

15. The system of claim 12, wherein the mission control includes a vehicle control unit configured to generate a limited behavior for the vehicle based on the trailer model.

16. The system of claim 15 wherein the limited behavior for the vehicle ensures prevention of collisions of the trailer during turning of the vehicle.

17. A computer-implemented method for trailer dimension estimation, comprising:
coupling a trailer with a vehicle, the vehicle including one or more sensors associated with the vehicle, the one or more sensors each having a field-of-view, wherein the trailer includes a front section disposed proximal to the vehicle and a rear section with a rear edge or a rear point disposed distal to the vehicle; and
executing instructions stored in a memory with a processing device in communication with the one or more sensors to perform operations comprising:
determining if a first edge or a first point of the trailer is detected within the field-of-view of the one or more sensors; and
if the first edge or the first point of the trailer is detected within the field-of-view of the one or more sensors, estimating a dimension of the trailer based on a signal from the one or more sensors.

18. The computer-implemented method of claim 17, wherein the one or more sensors include a first sensor disposed on a first side of the vehicle and a second sensor disposed on a second side of the vehicle.

19. The computer-implemented method of claim 18, wherein the first edge is the rear edge and the first point is the rear point, and wherein estimating the dimension of the trailer includes detecting a first section of the rear edge or the rear point with the first sensor and detecting a second section of the rear edge or the rear point with the second sensor, and estimating the trailer width based on the first section and the second section of the rear edge or the rear point of the trailer.

20. The computer-implemented method of claim 17, wherein the first edge is the rear edge and the first point is the rear point, and wherein if the rear edge or the rear point of the trailer is not detected within the field-of-view of the one or more sensors, the operations comprise initiating a turn motion of the vehicle and continuing the turn motion of the vehicle until the rear edge or the rear point of the trailer is detected within the field-of-view of the one or more sensors.
